(19) United States
(12) Patent Application Publication
(10) Pub. No.: US 2008/0244384 A1
(43) Pub. Date: Oct. 2, 2008

(54) IMAGE RETRIEVAL APPARATUS, METHOD FOR RETRIEVING IMAGE, AND CONTROL PROGRAM FOR IMAGE RETRIEVAL APPARATUS

(75) Inventor: Akihiro Yoshitani, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/049,016

(22) Filed: Mar. 14, 2008

(30) Foreign Application Priority Data
Mar. 26, 2007 (JP) 2007-078107

(51) Int. Cl. G06F 17/21; G06F 17/30

(52) U.S. Cl. 715/251

(57) ABSTRACT

An apparatus divides a document image of each page which is to be input and stored into a plurality of regions according to image attribute contained in the document image to generate layout analysis data of each region. Further, the image data of each page is classified so that the image data belongs to one of a plurality of clusters based on the analysis data. When the document image of the page is retrieved, representative layout images in each cluster are displayed. A user selects and specifies the layout representative image which is the closest to the layout of the document image of the page which the user memorizes and desires to retrieve. Thus, the cluster is specified, and the image data of a page belonging to the cluster is retrieved and output.

### BACKGROUND OF THE INVENTION

1. Field of the Invention

The present invention relates to an image retrieval apparatus, a method for retrieving an image, and a control program for the image retrieval apparatus. In this image retrieval apparatus, document image data is input by an inputting unit such as a scanner, and accumulated and stored in a storage unit such as a hard disk. A specified document image data is retrieved and output from among the document image data stored in the storage unit in response to user's specification.

2. Description of the Related Art

A large capacity memory device such as a hard disk, and an inputting unit such as a scanner for electronically reading document image data are in a widespread use. As a result, construction and storage of a large-scale document image database can be realized. Such a document image database is applicable to an electronic book, medical document, administrative record, electronic scrap, map, administrative format, and manual. These days, use of a document image database system is widespread since in general, storing the read document image in electronic media is less expensive than storing the document as it is.

Concerning the above described document image database system, Japanese Patent Application Laid-Open No. 2000-324331 discusses a method for compressing image data that is apt to become large, and effectively managing such data. In this method, first, an image of each page of the input document image data is divided into a plurality of regions according to the image attribute (e.g., text, graphic, table, and picture) contained in the target page. Then, the image in each region is subjected to a different compression process depending on the attribute to reduce the data amount of the entire page. Specifically, this method is performed according to the following procedures:
1) Digital image data (multi-valued image data) of one page is taken into an image processing apparatus. As the image taking unit, an image reading apparatus (scanner) attached to the apparatus is used that optically captures an image of the document. The captured image is converted to the digital image data. Alternatively, the document image data can be taken from an external apparatus through an interface unit such as a network;
2) Binary image data is generated from the taken image data of one page;
3) The image attribute contained in the document image of one page is determined based on the binary image data, and the image of one page is divided into a plurality of regions according to the image attribute. A method for determining the attribute of an image and dividing the image into a plurality of regions is described in, for example, U.S. Pat. No. 5,907,835. In the method, the image of the binary image data is divided into many small regions, and the attribute of the image is determined from the characteristic of the image data in each small region. Then, a set of the continuous small regions having the same attribute (e.g., the attribute of text) is extracted as a region of the attribute.
4) The binary image data or the multi-valued image data is selected in every attribute region according to the attribute and the selected data is compressed by a compression method that varies depending on the selected data; and
5) The compressed data in each region of one page is held together with information of the region such as the attribute, a coordinate value of location or size, and stored as the compressed data of the page.

The extension process is applied to the compression data in every attribute region which is obtained by dividing the image into the small regions. The extended data is pasted to the coordinate position of the region within an original image page, so that the image of a page is reproduced.

It is necessary to effectively distinguish and search the desired document in handling a large-scale document image database system. As a method for referring the desired document to the database, a text string or its combination presumed to be present in the desired document is retrieved. However, since this method requires optical character recognition process with high accuracy, it is difficult to realize the practical application.

There is another method for referring the desired document to the database, which assumes that a user has some knowledge of the appearance of the document that the user desires to retrieve. A method for using this appearance information to refer to the document image database is discussed in U.S. Pat. No. 5,933,823. The method is described hereinafter.

First, an example document image whose rough appearance is similar to the target document is generated by simple category selection or the like to obtain its image feature information. Second, the image feature information is used for searching the database to display the plurality of documents as the search result which have a similar appearance to the example document image. Third, as a key for the next search, the user selects a document, which has the most similar appearance to the desired document, from among the displayed search result. The next search is performed with the selected key. The desired document is finally retrieved by repeating the process.

U.S. Pat. No. 5,933,823 proposes the following three methods for presenting the example document image, which is used for a key for the first search, to the image database system:
1) finding one image having a similar appearance to the desired image from the database by using another retrieval unit;
2) reading an example image by using a reading apparatus, assuming that a user already has the example image made of paper; and
3) specifying the appearance of the desired image by a user who performs drawing using a graphical user interface. However, all these methods impose a burden on the user, which hinders the efficient search of the desired document image by a simple operation.

### SUMMARY OF THE INVENTION

An embodiment of the present invention is directed to providing an image retrieval device in which a user can efficiently retrieve the desired document image data by a simple operation.

According to an aspect of the present invention, an apparatus includes an inputting unit configured to input document image data; a layout analysis unit configured to divide the input document image data of each page into a plurality of regions according to attribute of an image of the page to generate layout information for each of the plurality of regions; a processing unit configured to classify the document image data of each page such that the document image data of each page belongs to one of a plurality of groups, based on the layout information stored in association with the document image data; a specification unit configured to specify one of the plurality of groups according to which a user requests to retrieve one or more pages of document image data; and a retrieval unit configured to retrieve one or more pages of document image data belonging to the group, which is specified by the specification unit, from among a plurality of pages of document image data.

According to an embodiment of the present invention, a user uses own memory of layout of a page of document image data, which the user desires to search, so that the search process can be performed only by specifying a group, to which the document image data of the page, which the user desires to search, belongs, according to the layout. Therefore, the user can efficiently search the desired document image data by a simple operation.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image retrieval apparatus of an embodiment of the present invention.

FIG. 2 is a flow chart illustrating a control procedure for registering and storing input document image data of a page.

FIGS. 3A to 3C are views illustrating an example of a layout analysis to be performed in registering document image data.

FIG. 4 is a view illustrating a layout representative image of each group when the document image data is classified according to layout of a text region and other image region.

FIG. 5 is a view in which the layout representative image of a group to which the layout is applied is displayed in a display unit in registering document image data of a page.

FIG. 6 is a flow chart illustrating a control procedure for search operation performed by using the layout of the document image data.

### DETAILED DESCRIPTION OF THE EMBODIMENTS

Various exemplary embodiments, features, and aspects of the invention will be described in detail below with reference to the drawings.

### Exemplary Embodiment

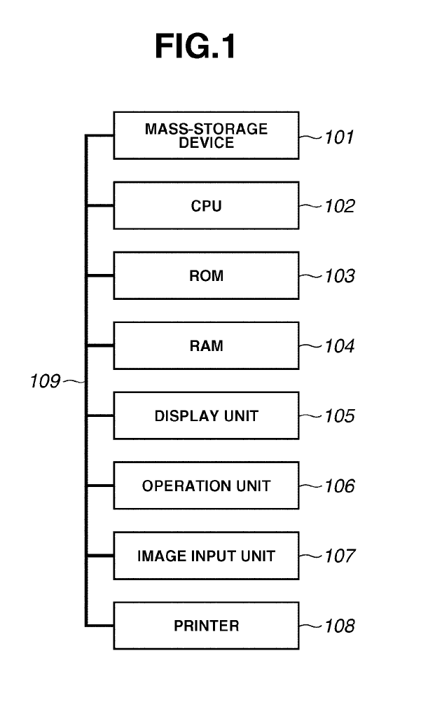

FIG. 1 is a block diagram illustrating a configuration of an image retrieval apparatus of an embodiment of the present invention. Units 101 to 108 are connected with each other through a bus 109.

A mass-storage device 101 as a storage unit with a large capacity can register and store a large amount of (a lot of) document image data, and includes a hard disk device and the like. The document image data is accumulated in the mass-storage device 101 so as to constitute a document image database which can realize the search by using a layout of an image of a page which will be described hereinafter.

A central processing unit (CPU) 102 is a control unit for overseeing and controlling the entire system of the image retrieval apparatus. The CPU 102 functions as a layout analysis unit for analyzing a layout of an image of each page of the document image data which is to be input (as described hereinafter). Additionally, the CPU 102 functions as a processing unit for classifying document image data in a unit of a page by using the layout, based on the layout information (layout analysis data) obtained in the layout analysis. Moreover, the CPU 102 is also a retrieval unit configured to retrieve the document image data in response to the user's specification based on the layout of the page.

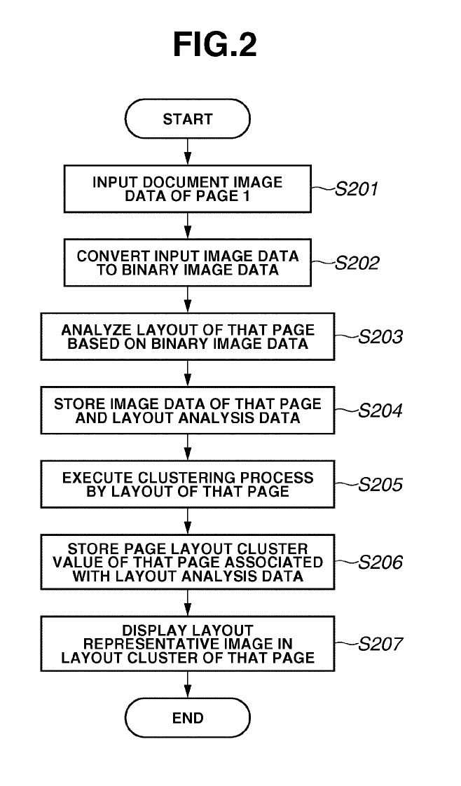

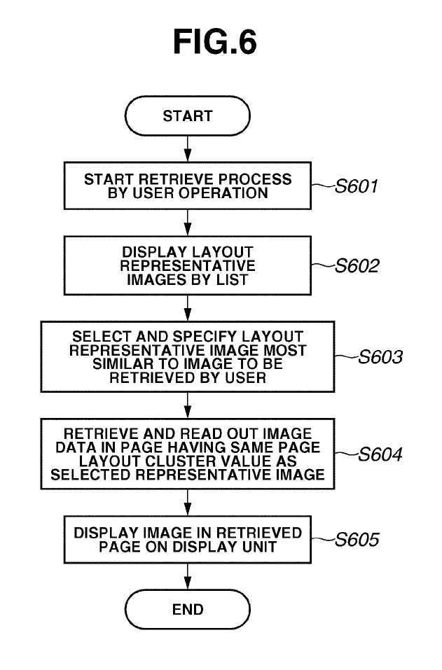

A read only memory (ROM) 103 stores a control program that is executed by the CPU 102. The control program includes the programs corresponding to each process of control procedures (described hereinafter) illustrated in flow charts of FIGS. 2 and 6.

A random access memory (RAM) 104 temporarily memorizes each data to be processed by the CPU 102.

A display unit 105 (output unit) includes a liquid crystal display device or the like capable of displaying bitmap image data.

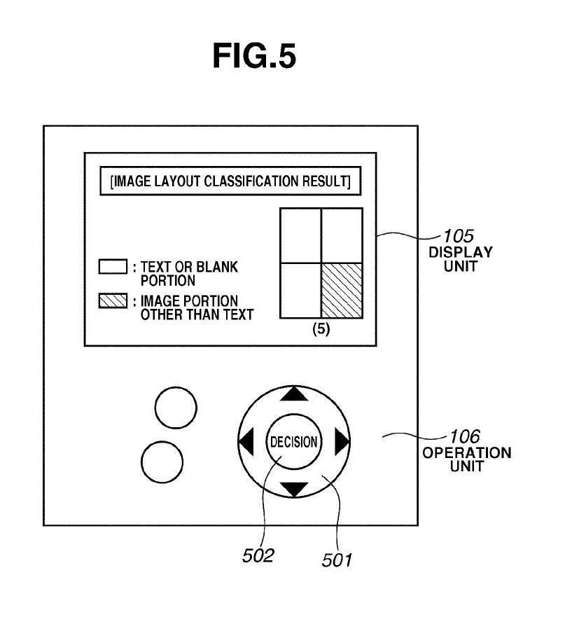

An operation unit 106 includes input keys used for performing each input. The user uses the keys to operate the image retrieval apparatus. Some of the input keys (a cursor key 501 and a determination key 502 in FIG. 5) are used as a specification unit when the user inputs the specification of the group according to the layout of the page to retrieve the document image data (as described hereinafter).

An inputting unit 107 is configured to input the document image data. Specifically, the inputting unit 107 is a scanner device for electrically reading the document image of a manuscript to convert the image into the image data, or an interface device for receiving the document image data from an external apparatus (not shown) through an appropriate interface.

A printer 108 outputs the image of the document image data, which has been obtained as the retrieval result, by printing the image on a sheet.

In the configuration, the CPU 102 controls the overall operation in response to the input from the keys in the operation unit 106 performed by a user. For instance, the CPU 102 registers the document image data, which is input by the inputting unit 107, to the mass-storage device 101; that is, the CPU 102 accumulates and stores the document image data. In addition, the CPU 102 searches and retrieves the document image data, which corresponds to the condition specified by a user, from the mass-storage device 101. The CPU 102 outputs the retrieved document image data by displaying the document image data in the display unit 105, or printing out the data using the printer 108.

In the registration operation, classifying is performed in which the document image data in a unit of page to be input is classified such that the document image data belongs to one of a plurality of groups according to the layout of each page having a text region and other image region. In the retrieval operation, the group to which the document image data of the page that the user desires to retrieve, belongs is specified according to the layout of the image of the page, based on the memory of the user itself about the layout of the page of the document which the user desires to retrieve. Subsequently, the document image data of the page belonging to the specified group is retrieved and output.

The registration operation of the document image data performing the classifying process according to the layout of the image of each page and the retrieval operation of the document image data in response to the group specified by the page layout are described hereinafter in detail.

FIG. 2 is a flow chart illustrating a procedure including the classifying process using the layout of the image of each page when the document image data is registered. In the classifying process, the document image data of a page to be input is processed. This process is applied to the document image data of each page which is to be sequentially input.

When the document image data is registered, first, in step S201, the inputting unit 107 inputs the document image data of a page as a multi-valued color image data under control of the CPU 102. The multi-valued color image data is represented, for example, as data of 24 bits, and it is temporarily stored in the RAM 104.

In step S202, the CPU 102 converts the input multi-valued image data into a binary image data. The conversion is performed at this stage to generate the binary image data in addition to the multi-valued image data, while the multi-valued image data is kept for later use.

In step S203, the CPU 102 as a layout analysis unit performs the layout analysis corresponding to the image attribute contained in the document image of the page, based on the binary image data. Namely, at first, the image attribute (e.g., text, graphic, table, picture, and photo) is determined. The image of a page is divided into a plurality of regions (n regions) according to the determined image attributes, and data in n regions is obtained. Then, data of layout information, that is, x and y coordinates at a point of origin (a point at the upper-left corner), width, and height, and the data of the attribute in each divided region are generated. Hereinafter, these data and the data of n regions are in all referred to as layout analysis data. The layout analysis is described in Japanese Patent Application Laid-Open No. 2000-324331. Further, the attribute of the image of a page is initially performed by dividing the image of a page into many small regions as described in U.S. Pat. No. 5,907,835.

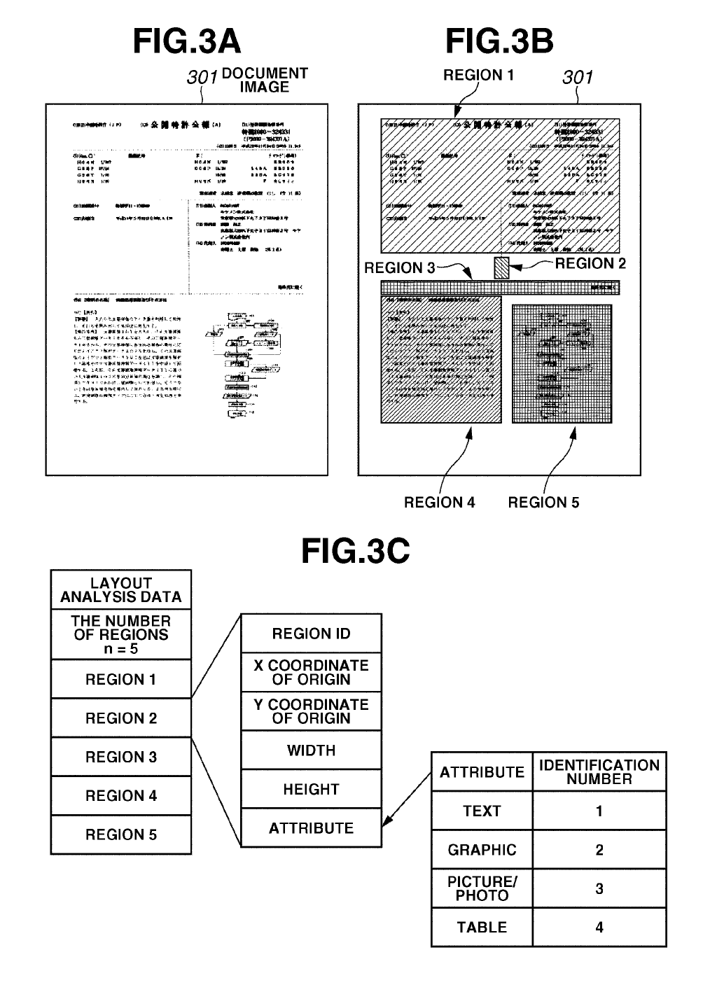

An example of the layout analysis process performed in step S203 is illustrated in FIGS. 3A to 3C. FIGS. 3A to 3C are views illustrating an example of the layout analysis performed when document image data is registered. When an input image is a document image 301 of a page as illustrated in FIG. 3A, the image 301 is divided into regions 1 to 5 as shown in FIG. 3B through the layout analysis according to the image attribute contained in the image 301. In this case, the attributes in the regions 1 and 4 are texts; meanwhile, the attributes in the regions 2, 3, and 5 are graphics. After the image 301 is divided, the layout analysis data as illustrated in FIG. 3C is generated. Here, the region number n is five. Then, data containing a region ID, x-coordinate of origin, y-coordinate of origin, width, height, and attribute are respectively generated for each of the regions 1 to 5. The attribute data is, for example, an identification number of each attribute; the text is represented by 1, the graphics is represented by 2, the picture and photo is represented by 3, and the table is represented by 4.

After the layout analysis is carried out, in step S204 in FIG. 2, the CPU 102 stores the document image data of each region (regions 1 to 5 in FIG. 3) of a page in the mass-storage device 101 in a data format corresponding to the image attribute, based on the layout analysis result. Specifically, when the attribute of the region is the text or graphic, the document image data is stored as the binary image data; meanwhile, when the attribute is the picture and photo, the document image data is stored as 24-bit color image data. The binary image data and the 24-bit color image data may be compressed by the appropriate compression methods respectively and stored. Thus, the data amount of the entire page can be reduced. Also the layout analysis data of each region of the page is stored in association with the image data of each region.

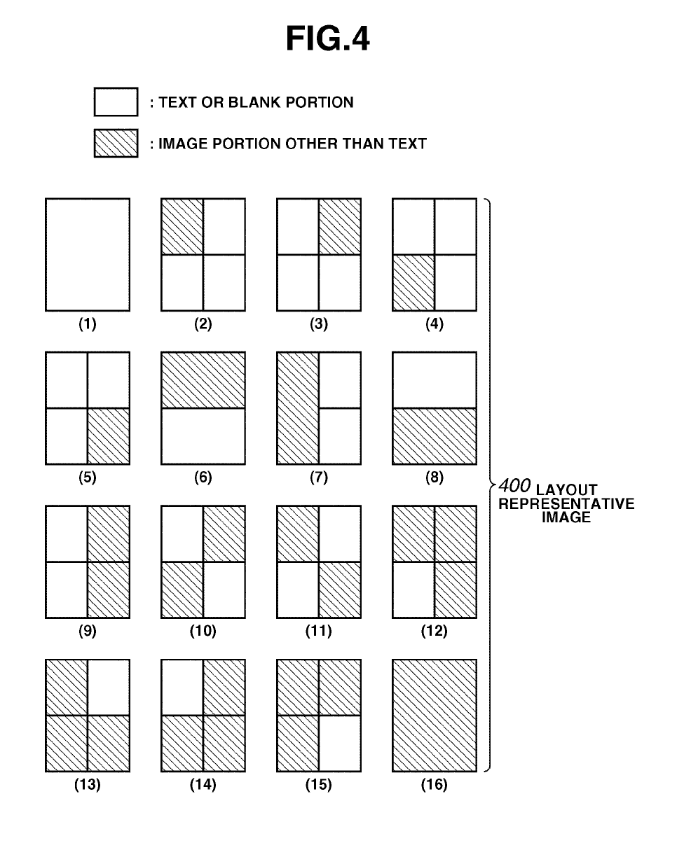

Next, in step S205, the CPU 102 executes the classifying process using the layout to the stored document image data of a page. The classifying process is performed based on the layout analysis data (layout information) as to the plurality of regions in a page which has been stored in association with the stored document image data of a page. In the classifying of the present exemplary embodiment, first, one page is divided into equal four regions having the size of 2×2. In the respective four regions, the area of the text or blank region and that of the image region other than text are compared in size. When the area of the text or blank region is larger than the image region, the region is determined as a text or blank portion; meanwhile, the area of the image region other than text is larger than the text or blank region, the region is determined as an image portion other than text. Then, it is determined into which pattern of layout images (1) to (16) illustrated in FIG. 4, the combination of the text or blank portion and the image portion in the four regions of the page is classified. FIG. 4 is a view illustrating layout representative images of respective groups when the document image data is classified according to the layout having the text region and the image region. Thus, the image of the page is classified into the group of the pattern to which the image of a page is applied. Any image of a page can be applied to any one of the sixteen patterns. The sixteen patterns are layout images illustrating a representative layout of the document image of a page in each group, and are referred to as the layout representative image with a number 400.

The classifying process is performed to obtain the information about the layout representative image 400 to which the layout of the image of a page is applied. Namely, the discrimination information of the group, into which the document image data of a page is classified and which is allocated according to the layout, is obtained. The discrimination information is referred to as a page layout group, and is represented by the numbers 1 to 16 which are attached to each layout representative image. For instance, while the document image 301 illustrated in FIG. 3A is divided into equal four regions having the size of 2×2, the area occupied by a graphic region is the largest within the lower right part of the image; meanwhile, most of the remaining area is occupied by the text region. Therefore, a number of the page layout group is 5. Although the page layout group is represented by the numbers here, the page layout group may also be represented by anything other than the number.

In step S206, the CPU 102 stores the numeric data of the page layout group of the image of a page which has been obtained in step S205, in the mass-storage device 101. The numeric data is stored in association with the layout analysis data of this page already stored therein, i.e., in association with the already stored document image data of this page.

In step S207, in order to inform the classification result of the clustering using the layout to the user, the CPU 102 displays the layout representative image of the group in the display unit 105 into which the document image data of a page is classified and belongs, from among sixteen patterns of the group illustrated in FIG. 4. For instance, since the number of the page layout group of the document image 301 is 5, the layout representative image having the group 5 is displayed in the display unit 105 as illustrated in FIG. 5. FIG. 5 shows that the layout representative image of the group, to which the layout of a certain document image data of a page is applied, is displayed in the display unit 105 when the document image data is registered. Thus, the classification result according to the layout is informed to the user. This process enables a user to easily select the layout to be specified when the user retrieves the subject page later. When the process in step S207 is finished, the registration process of the document image of a page is finished. The above-described process is applied to the document image data of each page which is successively input.

FIG. 6 is a flow chart illustrating a control procedure of the retrieval operation using the layout of the document image data.

First, in step S601, when the user operates the input key of the operation part 106 to instruct the retrieval process, the CPU 102 starts the retrieval process of the document image data accumulated in the mass-storage device 101.

In step S602, the CPU 102 displays the layout representative images 400 having sixteen patterns illustrated in FIG. 4 in the display unit 105 by list.

In step S603, among the sixteen patterns of layout representative images 400 displayed in step S602, the user determines which is most similar to the layout of the text part and the image part of the document image page which the user desires to retrieve. Then, input is performed to select and specify the layout representative image determined to be most similar using the cursor key 501, the determination key 502 (see FIG. 5), or the like in the operation unit 106. Thus, the group to which the document image data of the page belongs is indirectly specified according to the layout of the document image page which the user desires to retrieve.

In step S604, the CPU 102 retrieves the document image data of the page which belongs to the group specified by the layout representative image. Namely, first, the numeric value which is the same as the numeric value of the group of the layout representative image selected by the user in step S603 is retrieved from among the numeric value data of the page layout group of the document image of each page stored in the mass-storage device 101. Then, the document image data of one or a plurality of pages stored in association with the retrieved numeric data of the page layout group is searched and retrieved.

In step S605, the CPU 102 outputs the document image data of one or a plurality of pages retrieved in step S604 to the display unit 105 to display the image of the page. Then, the process is finished.

The user selects the desired document image data from one or plural pages of displayed image of the document image data, and performs operations such as printing. When a large number of the pages is retrieved, the document image data of the retrieved pages is further searched and narrowed down by other methods.

As described above, according to the image retrieval apparatus of the present exemplary embodiment, when the user attempts to retrieve the desired document image data, the layout representative images of a plurality of pages are displayed. Then, in performing the retrieval process, the user selects and specifies only a displayed layout representative image which has most similar layout to a document page which the user memorizes and desires to retrieve, based on the text or blank region and the image region in the document page. Further, it is possible to retrieve the page which the user desires, by an extremely simple operation using a user's memory of the layout of the document image of the page.

In the present exemplary embodiment, the number of the layout representative images, i.e., the number of the group corresponding to the image layout of a page, is sixteen. However, the number of the group is not limited to sixteen. In addition, the patterns of the layout representative images are not limited to those illustrated in FIG. 4.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-078107 filed Mar. 26, 2007, which is hereby incorporated by reference herein in its entirety.

What is claimed is:

1. An apparatus comprising:
an inputting unit configured to input document image data;
a layout analysis unit configured to divide the document image data into a plurality of regions according to attribute thereof to generate layout information for the plurality of regions in a unit of a page;
a processing unit configured to classify each page of document image data into one of a plurality of groups, based on corresponding layout information generated by the layout analysis unit;
a specification unit configured to specify one of the plurality of groups according to which a user requests to retrieve one or more pages of document image data; and
a retrieval unit configured to retrieve one or more pages of document image data belonging to the group, which is specified by the specification unit, from among a plurality of pages of document image data.

2. The apparatus according to claim 1, further comprising a display unit configured to display a plurality of layout images representing a representative layout of a document image of a page in each of the plurality of groups, wherein the group to which the requested document image data of the page belongs is specified by specifying one of the plurality of layout images displayed in the display unit by the specification unit.

3. The apparatus according to claim 1, further comprising an output unit configured to indicate the group to which image data of a page belongs, after the processing unit classifies the document image data of a page into one of the plurality of groups.

4. The apparatus according to claim 3, wherein the output unit comprises a display unit configured to display a layout image representing a representative layout of a document image of a page in the group to which the document image data of a page belongs.

5. The apparatus according to claim 1, wherein the processing unit divides each page of document image data into specified regions to determine an area of image data, which has different attributes, from the layout analysis data in each of the divided region, and thus classifies the image data based on the determined area.

6. The apparatus according to claim 1, further comprising a storage unit to store the document image data with the corresponding layout information generated in a unit of the page by the layout analysis unit.

7. A method comprising:
inputting document image data;
dividing each page of the document image data into a plurality of regions according to image attribute thereof to generate layout information for the plurality of regions;
classifying each page of the document image data into one of a plurality of groups, based on corresponding layout information;
specifying one of the plurality of groups according to which a user requests to retrieve one or more pages of document image data; and
retrieving one or more pages of document image data belonging to the specified group, from among a plurality of pages of the document image data.

8. The method according to claim 7, further comprising displaying a plurality of layout images representing a representative layout of a document image data of a page in each of the groups, wherein one of the displayed layout images is specified to specify the group to which the requested document image data of the page belongs.

9. The method according to claim 7, further comprising outputting information indicating the group to which document image data of a page belongs, after classifying the document image data of a page to any one of the plurality of groups.

10. The method according to claim 9, further comprising displaying a layout image representing a representative layout of a document image of a page in the group to which the document image data of a page belongs.

11. A computer-readable storage medium storing a program for causing an apparatus to execute the method according to claim 7.
